(19) United States
(12) Patent Application Publication
(10) Pub. No.: US 2007/0120461 A1
(43) Pub. Date: May 31, 2007

(54) FLAT PANEL DISPLAY DEVICE

(76) Inventors: Masahiro YOKOTA, Fukaya-shi (JP); Daiji HIROSAWA, Fukaya-shi (JP); Yoshiki ORIMOTO, Fukaya-shi (JP); Koji TAKATORI, Ageo-shi (JP); Hirotaka MURATA, Fukaya-shi (JP); Masaaki FURUYA, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/624,713

(22) Filed: Jan. 19, 2007

Related U.S. Application Data
(63) Continuation of application No. PCT/JP05/13650, filed on Jul. 26, 2005.

(30) Foreign Application Priority Data
Jul. 27, 2004 (JP) 2004-219156
Jul. 27, 2004 (JP) 2004-219157

(51) Int. Cl. H01J 63/04; H01J 1/62

(52) U.S. Cl. 313/495; 313/497

(57) ABSTRACT

A flat panel display device, in which a getter layer employed has a region including a striped discontinuous portion in an image display region, and the discontinuous portion is formed by forming the getter layer on an underlayer formed with microstructures on its surface, or the phosphor screen includes a two-dimensional array of pixels each including a red-emitting phosphor element, a green-emitting phosphor element, and a blue-emitting phosphor element that are arrayed at predetermined intervals to form one unit, and the interval of the pixels is larger than the interval of R, G, and B phosphor elements.

### CROSS-REFERENCE TO RELATED APPLICATIONS

This is a Continuation Application of PCT Application No. PCT/JP2005/013650, filed Jul. 26, 2005, which was published under PCT Article 21(2) in Japanese.

This application is based upon and claims the benefit of priority from prior Japanese Patent Applications No. 2004-219156, filed Jul. 27, 2004; and No. 2004-219157, filed Jul. 27, 2004, the entire contents of both of which are incorporated herein by reference.

### BACKGROUND OF THE INVENTION

1. Field of the Invention

The present invention relates to a flat panel image display device which uses electron-emitting elements.

2. Description of the Related Art

In recent years, a flat panel image display device in which a large number of electron-emitting elements are arranged to oppose a phosphor screen has been under development as the next-generation image display device. Various types of electron-emitting elements are available which basically employ field emission. Display devices which use such electron-emitting elements are generally called field emission displays (to be referred to as FEDs hereinafter). Of the FEDs, a display device that uses a surface conduction emitter is also called a surface conduction electron-emitting display (to be referred to as an SED hereinafter). In this application, FED is employed as a general term that also includes SED.

Generally, an FED has a front substrate and a rear substrate which oppose each other at a predetermined gap. These substrates bond to each other at their peripheral portions through a rectangular frame-shaped side wall to form a vacuum envelope. The interior of the vacuum envelope is maintained at a high vacuum with a vacuum degree of about 10⁻⁴ Pa or less. To support the load of the atmospheric pressure acting on the rear substrate and the front substrate, support members are disposed between the substrates.

The inner surface of the pixel region of the front substrate has a phosphor screen including red-emitting (R), blue-emitting (B), and green-emitting (G) phosphor layers. The inner surface of the rear substrate is provided with a large number of electron-emitting elements which emit electrons to excite phosphors to emit light. A large number of scanning lines and signal lines form a matrix and connect to the respective electron-emitting elements. Voltages corresponding to video signals are applied to the electron-emitting elements through the scanning lines and the signal lines.

An anode voltage is applied to the phosphor screen. Electron beams emerging from the electron-emitting elements are accelerated by the anode voltage to bombard the phosphor screen, so the phosphors emit light to display an image.

In such an FED, the gap between the front substrate and the rear substrate can be set to several mm or less. This can achieve a lower weight and a smaller thickness when compared to a cathode-ray tube (CRT) used as a display for a current television or computer.

In the FED having the above arrangement, to obtain practical display characteristics, phosphors similar to those in an ordinary cathode-ray tube must be formed. Also, a phosphor screen having an aluminum thin film called a metal back on the phosphors must be used.

In this case, the anode voltage to be applied to the phosphor screen is desirably a minimum of several kV and, if possible, 10 kV or more. Due to the resolution and the characteristics of the support member, however, the gap between the front substrate and the rear substrate cannot be increased excessively, and must be set to about 1 to 2 mm. Therefore, in the FED, when a high anode voltage is applied to the phosphor screen, a strong field is inevitably generated in the small gap between the front substrate and the rear substrate. This causes the problem of discharge (dielectric breakdown) between the two substrates.

When discharge occurs, a current of 100 A or more may flow momentarily. This may destroy or degrade the electron-emitting elements or the phosphor screen, or even destroy a driving circuit. These phenomena are altogether called damage caused by discharge. Such discharge that may lead to a defective product is not allowable. Therefore, to put an FED into practical use, no damage caused by discharge should occur over a long period. It is, however, very difficult to suppress discharge completely over a long period.

In another countermeasure, discharge is allowed to happen but its scale is suppressed, so even when discharge should occur, its influence on the electron-emitting elements is negligible. As a technique associated with this idea, for example, Jpn. Pat. Appln. KOKAI Publication No. 2000-311642 discloses a technique with which cut-outs are formed in a metal back formed on a phosphor screen to obtain, e.g., a zigzag pattern. This increases the effective inductance and resistance of the phosphor screen. Also, Jpn. Pat. Appln. KOKAI Publication No. 10-326583 discloses a technique of dividing or segmenting a metal back.

When employing these techniques, a partial region of the metal back formed in advance must be removed by some means. Alternatively, a manufacturing method is required which, when forming a metal back, performs masking so the metal back is formed in segments only at predetermined regions.

Also, to maintain the vacuum degree over a long period, the following method is preferable. Namely, the vacuum chamber is not evacuated after sealing the panel, but a gas adsorption film generally called a getter is formed on the phosphor screen in the vacuum chamber, and the front substrate and the rear substrate are sealed without exposing them to the atmosphere.

In this case, when the metal back is segmented as described above, the getter layer undesirably forms a continuous film, and the segmentation effect of the metal back layer is lost practically. Therefore, the getter layer must also be segmented.

### BRIEF SUMMARY OF THE INVENTION

The present invention is made to solve the above problems, and has as its object to provide a flat panel display device in which the scale of discharge decreases to prevent the electron-emitting elements and the phosphor screen from being destroyed or degraded, and the circuit from being destroyed, and a manufacturing method for the same.

A flat panel display device according to the first aspect of the present invention, which has a vacuum envelope including a front substrate and a rear substrate arranged to oppose the front substrate, and in which a phosphor screen, a metal back layer, an underlayer, and a getter layer are sequentially formed on a surface of an image display region of the front substrate on a side close to the rear substrate, in which the getter layer comprises a region including a striped discontinuous portion in the image display region, and the discontinuous portion is formed by forming the getter layer on the underlayer provided with microstructures on a surface thereof.

A flat panel display device according to the second aspect of the present invention, which has a vacuum envelope including a front substrate and a rear substrate arranged to oppose the front substrate, and in which a phosphor screen, a metal back layer, an underlying layerunderlayer, and a getter layer are sequentially formed on a surface of an image display region of the front substrate on a side close to the rear substrate, in which the phosphor screen comprises a two dimensional array of pixels each including a red emitting phosphor element, a green emitting phosphor element, and a blue emitting phosphor element that are arrayed at predetermined intervals to form one unit, and an interval (W2) of the pixels is larger than an interval (t1) among the red emitting phosphor element, the green emitting phosphor element, and the blue emitting phosphor element.

### BRIEF DESCRIPTION OF THE SEVERAL VIEWS OF THE DRAWING

FIG. 1 is a perspective view showing an FED according to an embodiment of the present invention;

FIG. 2 is a sectional view of the FED taken along the line A-A of FIG. 1;

FIG. 3 is a schematic plan view to explain an example of the arrangement of the phosphor screen and the metal back layer in FIG. 2;

FIG. 4 is a sectional view of part of FIG. 3;

FIG. 5 is a schematic view to explain an example of a getter layer employed in the present invention;

FIG. 6 is a view showing part of FIG. 5;

FIG. 7 is a view to explain the discontinuous layer in FIG. 5;

FIG. 8 is a view to explain the discontinuous layer in FIG. 5;

FIG. 9 is a schematic plan view to explain another example of the arrangement of the phosphor screen and the metal back layer in FIG. 2;

FIG. 10 is a sectional view of part of FIG. 9;

FIG. 11 is a schematic view to explain another example of the getter layer employed in the present invention;

FIG. 12 is a view showing the relationship between the electron-emitting elements and R, G, and B phosphors in a device according to the present invention; and

FIG. 13 is a view to explain an example of the shape of the electron beam spot of the device according to the present invention.

### DETAILED DESCRIPTION OF THE INVENTION

The present invention will be described in detail with reference to the drawing.

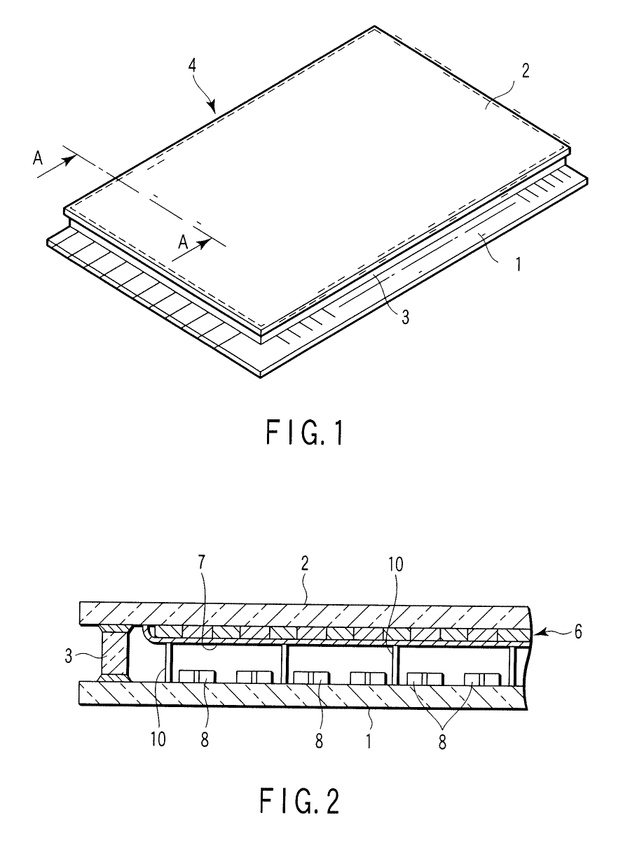

FIG. 1 is a perspective view showing an example of an FED as a flat panel display device according to the present invention.

FIG. 2 is an A-A sectional view of the same.

As shown in FIGS. 1 and 2, this FED comprises a front substrate 2 and a rear substrate 1 respectively formed of rectangular glasses. The substrates are arranged to oppose each other at a gap of 1 to 2 mm. The front substrate 2 and the rear substrate 1 bond to each other at their peripheral portions through a rectangular frame-shaped side wall 3 to form a flat, rectangular vacuum envelope 4 with an interior that is maintained at a high vacuum of about 10⁻⁴ Pa or less.

The inner surface of the image region of the front substrate 2 has a phosphor screen 6. The phosphor screen 6 comprises phosphor layers that emit red, green and blue light, and a matrix-shaped black light-shielding layer, as will be described later. The phosphor layers form, e.g., stripes or dots. The phosphor screen 6 has a metal back layer 7, which serves as an anode electrode, on it. When displaying an image, a predetermined anode voltage is applied to the metal back layer 7.

The inner surface of the rear substrate 1 is provided with a large number of electron-emitting elements 8 which emit electron beams to excite the phosphor layers. The electron-emitting elements 8 are arrayed in columns and rows to correspond to the respective pixels. The electron-emitting elements are driven by signals from matrix wiring lines (scanning lines and signal lines) (not shown).

A large number of plate- or column-like spacers 10 are arranged between the rear substrate 1 and the front substrate 2 to support the load of the atmospheric pressure acting the substrates.

An anode voltage is applied to the phosphor screen 6 through the metal back layer 7. Electron beams emitted from the electron-emitting elements 8 are accelerated by the anode voltage and bombard the phosphor screen 6. Accordingly, the corresponding phosphor layers emit light to display an image.

The phosphor screen 6 and the metal back layer 7 according to the first aspect that can be applied to the FED will be described in detail. Although the term metal back layer is used in the present invention, the material of the metal back layer is not limited to a metal, but various types of conductive materials can be used.

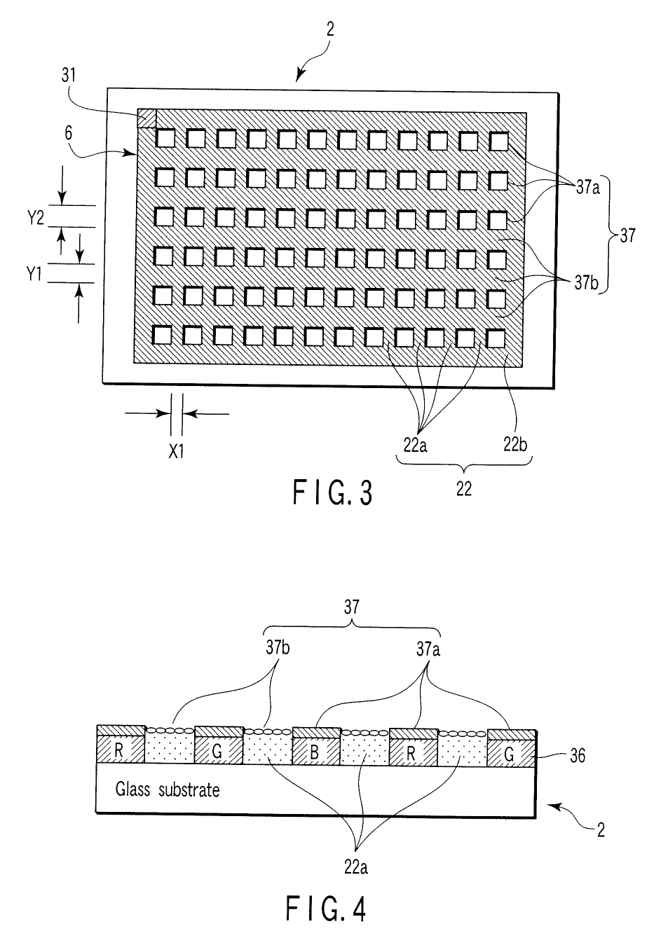

FIG. 3 is a schematic plan view to describe an example of the arrangement of the phosphor screen and the metal back layer in FIG. 2.

FIG. 4 is a sectional view of part of FIG. 3.

Referring to FIG. 3, the region indicated by hatched lines corresponds to the pattern of a black light-shielding layer 22. A phosphor screen 36 is an example of the phosphor screen 2 in FIG. 2. A metal back layer37 is an example of the metal back layer 7 in FIG. 2.

The pattern of the black light-shielding layer 22 comprises a grid pattern 22a with a row region and a column region either one of which is wider than the other, and a rectangular frame pattern 22b running along the periphery of the phosphor screen 36. The metal back layer 37 is formed to cover almost the entire surface of the black light-shielding layer 22. Both regions of the grid pattern can have equal widths.

When seeing the section, as shown in FIG. 4, as the phosphor screen 36, the black light-shielding layer 22 and phosphor layers 5R, 5G, and 5B are formed on, e.g., the glass substrate 2. The metal back layer 37 is formed on the phosphor screen 36. A phosphor layer 5 is formed in dot-shaped regions partitioned by the pattern of the black light-shielding layer 22, by arraying the red-emitting phosphor layers 5R, the green-emitting phosphor layers 5G, and the blue-emitting phosphor layers 5B regularly.

The metal back layer 37 is formed on almost the entire surface of the phosphor screen 36 at once with a vacuum thin film process. For example, a metal back layer 37 is formed by depositing aluminum on the phosphor screen 36 in a vacuum atmosphere. In this case, if the metal back layer 37 is directly formed on the red-emitting phosphor layers 5R, the green-emitting phosphor layers 5G, and the blue-emitting phosphor layers 5B, a mirror surface cannot be obtained because the deposition surfaces of the phosphor layers are not even. Hence, the following method is widely known. Namely, the surfaces of the red-emitting phosphor layers 5R, the green-emitting phosphor layers 5G, and the blue-emitting phosphor layers 5B are smoothed with a lacquer or the like. After that, the metal back layer 37 is formed by deposition.

Segmentation of the metal back layer 37 can be realized by selectively oxidizing, e.g., only a region 37b located on the black light-shielding layer 22. In this case, a paste that can oxidize the metal back layer 37 is printed on only the region 37b, and only the desired region can be oxidized by calcination.

When segmenting the metal back layer 37 in this manner, regions 37a that remain like islands are isolated electrically, and the high voltage from a high-voltage supply terminal portion 31 cannot be transmitted to the entire image region. For this reason, the region 37b is imparted with high-resistant conductivity within such a range that the damage of discharge may be moderated but conduction of the high voltage is not hindered. For example, a high-resistant material (not shown) film is formed on the region 37b by printing so the sheet resistance difference between the regions 37a and 37b becomes about 10⁵ Ω/□.

The present invention employs an expression “electrical segmentation”. In general, no one insulator has an infinitely large resistance, and cannot be electrically segmented in the strict sense. The present invention, however, expresses as electrical segmentation a situation in which an insulator forms a discontinuous film to have a greatly larger resistance (large resistance) than a continuous film.

With the FED having the above arrangement, the metal back layer 37 serving as a conductive thin film has the electrically discontinuous region 37b in a region that overlaps the black light-shielding layer 22. Even when discharge occurs between the front substrate 2 and the rear substrate 1, the discharge current can be suppressed sufficiently to avoid damage caused by the discharge.

This can suppress the damage of discharge to supply a highly reliable product.

The above description exemplifies formation of the discontinuous conductive thin film portion 37b on the black light-shielding layer 22 when forming the metal back layer 37. Various types of methods are available to form such discontinuous conductive thin film portion 37b.

For example, vapor deposition of the metal back layer 37 through a mask having only openings corresponding to the phosphor layers can achieve similar segmentation.

The segmentation region of the metal back layer 37 is the portion of the region 37b. Considering the region 37b, it has rows (Y1) arrayed with pixel intervals in the vertical direction and rows (X1) arrayed with pixel intervals in the horizontal direction. The rows and columns are located among the light-emitting elements. The rows and columns also correspond to the black matrix region.

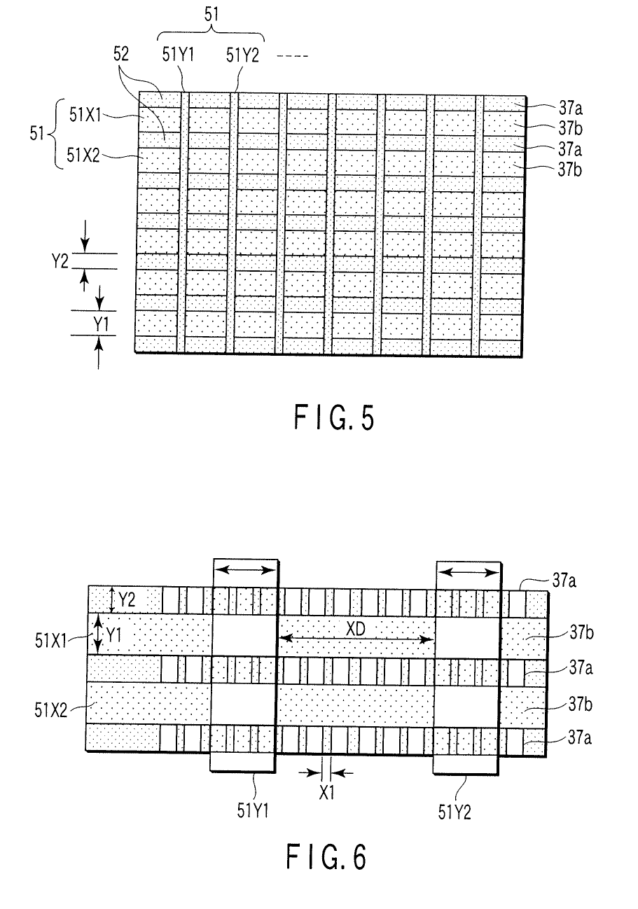

FIGS. 5 to 8 are schematic views to describe an example of the getter layer employed in the present invention.

According to the present invention, the getter layer is formed on the metal back layer 37 throughout the entire image display region and sealed without being exposed to the atmosphere. As the getter layer is made of a metal, when forming the getter layer, it must be segmented vertically and horizontally in the same manner as the metal back.

In FIGS. 5 to 8, a getter segmentation region 51 includes regions 51Y1, 51Y2 . . . , 51X1, 51X2 . . . .

FIG. 6 shows part of FIG. 5 by extraction which corresponds to a portion of “a region with no getter layer masked” a predetermined-interval gap. The region 37b of the metal back layer corresponds to portions of some of 51Y1, 51Y2, 51X1, and 51X2, and the regions 37a correspond to regions that are left out in rectangular patterns by the region 37b. The width of the portion having no getter layer is set to 100 μm or more. The width of the gap can be determined by the width of masking when forming the getter layer.

Segmentation along the vertical direction of the getter layer is done by not forming a getter layer in the regions 51X1, 51X2 . . . using wire masks running in the vertical direction when forming the getter. The wire masks are not aligned to perform mask deposition with a very simple device structure. Pixel portions where no getter layer is formed become free from electron energy loss caused by the getter layer, and have a slightly higher luminance than the getter film pixel portions. According to this embodiment, the width of each of 51X1, 51X2 . . . , and the like which are covered by 51Y1, 51Y2 . . . , and the like is equal to the width of the pixel of each of R, G, and B, so color misregistration due to a difference in luminance does not occur.

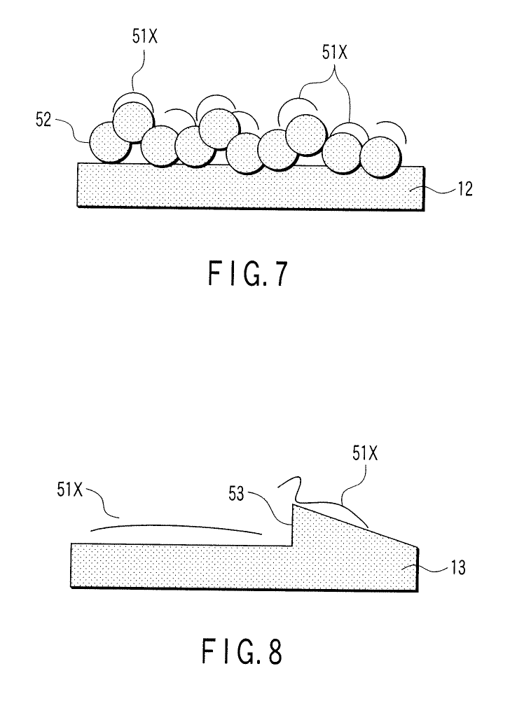

For achieving segmentation along the horizontal direction of the getter layer, granular microstructures 52 can be formed on an underlayerunderlayer 12 of a horizontal line region Y1 having no phosphor layer, as shown in FIG. 7, or a stepped microstructure 53 can be formed in advance on an underlayerunderlayer 13 of a horizontal line region Y1 having no phosphor layer, as shown in FIG. 8. When forming a getter by, e.g., deposition, part of the getter layer fractures as indicated by 51X due to the underlying microstructures, to form a discontinuous portion. The getter layer in the region including the discontinuous portion has a higher electrical resistance than a continuous getter layer in a region other than this region. This can downscale discharge to prevent the electron-emitting elements and the phosphor screen from being destroyed or degraded, or the circuit from being destroyed.

Hence, when forming the getter, the portions 51X1, 51X2 . . . , and 51Y1, 51Y2 . . . corresponding to the region 37b can be segmented to form the island-like regions 37a.

The width of the region to be masked by the wire masks is not limited to that described above. With a view to prevent color nonuniformity, masking is preferably performed using a multiple integer of the R-, G-, or B-color pixel as a unit.

In the phosphor layer arrangement as described above, that is, when the phosphor pixel interval has a small width along the vertical direction and a large width along the vertical direction, it is preferable to form microstructures on the underlayerunderlayer along the horizontal direction of the large width and perform masking in the vertical direction of the small width. This is because when forming the microstructures, a formation process margin is required. If the width is large, an inexpensive process can be employed easily. According to this embodiment, the microstructures are formed by printing. Segmentation in the vertical direction along which the margin is difficult to obtain can be implemented at a low cost by using alignment-free masking. More specifically, if two-dimensional segmentation is divided into two types of segmentation methods, i.e., formation of underlying microstructures in one-dimensional direction and masking in the remaining one-dimensional direction, the drawbacks of the two masking methods can be compensated for. If the arrays of the phosphor layers are rotated by 90°, the vertical and horizontal segmentation directions may be interchanged.

When forming the getter layer, the wires are arranged on the masking region to be spaced apart from the metal back layer. This is because if the wires are in tight contact with the metal back layer, they may damage the metal back layer. In practice, wires are set close to the metal back layer with a gap of preferably 0.1 mm or more and more preferably 0.2 to 1 mm. If the gap is 1 mm or more, the segmentation degrades as it reflects the size of the getter deposition source.

The present invention is not limited to the above embodiment. The above example includes getter layer segmentations 51Y1, 51Y2, . . . in the vertical direction. Depending on the area of the image display region, however, at least one segmentation column suffices. The direction of the color pixel array is not limited to that in the above embodiment. The RGB array may exist in the vertical direction. According to the present invention, when forming the getter layer, it is formed in a vacuum and sealed in the vacuum to form an envelope.

As described above, according to the first aspect, a flat panel display device can be obtained, which has a vacuum envelope including a front substrate and a rear substrate arranged to oppose the front substrate, and in which a phosphor screen, a metal back layer, an underlayerunderlayer, and a getter layer are sequentially formed on a surface of an image display region of the front substrate on a side close to the rear substrate, wherein at least the getter layer comprises a region including a discontinuous portion at least in the row or column direction of the image display region, and the discontinuous portion is arranged by forming the getter layer on the underlayerunderlayer provided with microstructures on its surface.

According to another aspect of the present invention of the first viewpoint, a gap having a predetermined interval can be further formed in a direction intersecting the region including the discontinuous portion. Electrical segmentation obtained by the high-resistance region including the discontinuous portion and the gap having the predetermined interval further decreases the scale of discharge to prevent electron-emitting elements and the phosphor screen from being destroyed and degraded, the circuit from being destroyed, and the like more effectively.

With the flat panel display device having the above arrangement, a high-resistance portion can be provided two-dimensionally with respect to the getter layer. First, (1) the scale of discharge can be decreased effectively. (2) In the high-resistance portion in one direction, the microstructures on the underlayer form the discontinuous portion. In the high-resistance portion in the other direction, a region having no getter layer is formed to have an almost constant width. Thus, a method and device that are easy as the manufacturing means can be selected.

The phosphor screen 6 and the metal back layer 7 according to the second aspect that are employed in the FED will be described in detail.

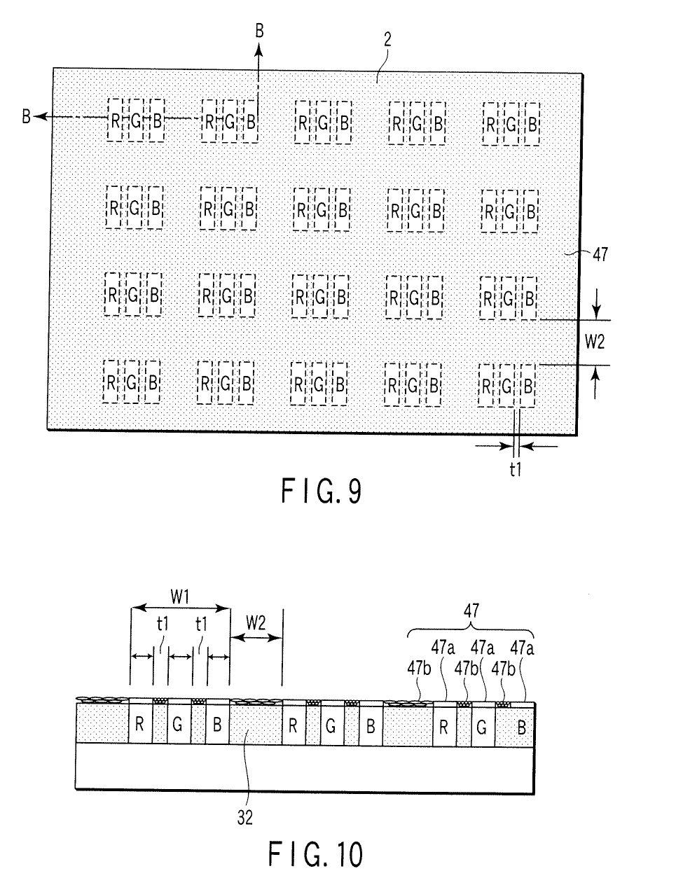

FIG. 9 is a schematic plan view to describe another example of the arrangement of the phosphor surface and the metal back layer in FIG. 2.

FIG. 10 is a sectional view of part of FIG. 9.

In FIG. 9, a region where a metal back layer37 is to be formed corresponds to the pattern of the black light-shielding layer 22. A phosphor screen 46 is an example of the front substrate 2 in FIG. 2. A metal back layer 47 is an example of the metal back layer 7 in FIG. 2.

As shown in FIGS. 9 and 10, when seeing the section, the phosphor screen 46 formed on the inner surface of a front substrate 2 has phosphor layers R, G, and B and a black light-shielding layer (black matrix) 32, as shown in FIG. 10, and is made of an electrically insulating material. The phosphor layers are arrayed to form groups each having a combination of R, G, and B.

The black light-shielding layer 32 is arranged to cover portions other than the layers of phosphors R, G, and B which are rectangular and arrayed at predetermined intervals. This arrangement is employed to suppress reflection of external light and reduce image darkening. The rear substrate corresponding to the phosphors R, G, and B is provided with electron beam-emitting elements. Electron beams from the electron beam-emitting elements irradiate the phosphors R, G, and B to emit red, green, and blue light. Regarding the electron-emitting elements, the phosphor layers are also arrayed to form groups each having a combination of R, G, and B. As shown in FIG. 9, for example, an interval t1 between phosphor layers in one pixel can be 20 μm, and a pixel distance W2 can be 300 μm.

As described above, according to the second aspect of the present invention, a flat panel display device can be obtained, which has a vacuum envelope including a front substrate and a rear substrate arranged to oppose the front substrate, and in which a phosphor screen, a metal back layer, an underlayer, and a getter layer are sequentially formed on a surface of an image display region of the front substrate on a side close to the rear substrate, wherein the phosphor screen comprises a two-dimensional array of pixels each including a red-emitting phosphor element, a green-emitting phosphor element, and a blue-emitting phosphor element that are arrayed at predetermined intervals to form one unit, and the interval (W2) of the pixels is larger than the interval (t1) among the red-emitting phosphor element, the green-emitting phosphor element, and the blue-emitting phosphor element. As a result, a high-resistance portion can be formed, in the region which achieves a sufficient process margin, two-dimensionally with respect to the getter film. This can reduce the scale of discharge.

The metal back layer 47 is formed on almost the entire surface of a phosphor screen 36 at once by a vacuum thin film process. For example, the metal back layer 47 is formed by depositing aluminum on the phosphor screen 36 in a vacuum atmosphere. At this time, the metal back layer 47 can be formed to be segmented into islands each corresponding to a block of the R, G, and B phosphor elements. The metal back layer 47 can be segmented by, e.g., a method of printing an oxidizable paste and oxidizing only a desired region by calcination, in the same manner as in the first aspect, and a method of forming the metal back layer by deposition through a mask only having openings corresponding to the phosphor layers. The segmented region is formed to have a resistance sufficient to suppress discharge damage and allow the high voltage from a high-voltage terminal (not shown) to be transmitted to the entire image region. More specifically, the discharge damage is adjusted by, e.g., providing a resistance layer having an appropriate resistance.

According to the FED having the above arrangement, the metal back layer 47 serving as a conductive thin film has continuous conductive portions 47a at a region overlapping the phosphor layers R, G, and B, and an electrically discontinuous conductive thin film portion 47b at a region overlapping the black light-shielding layer 32. Even when discharge occurs between the front substrate 2 and a rear substrate 1, the electrically discontinuous conductive thin film portion 47b can sufficiently suppress the discharge current to avoid damage caused by the discharge.

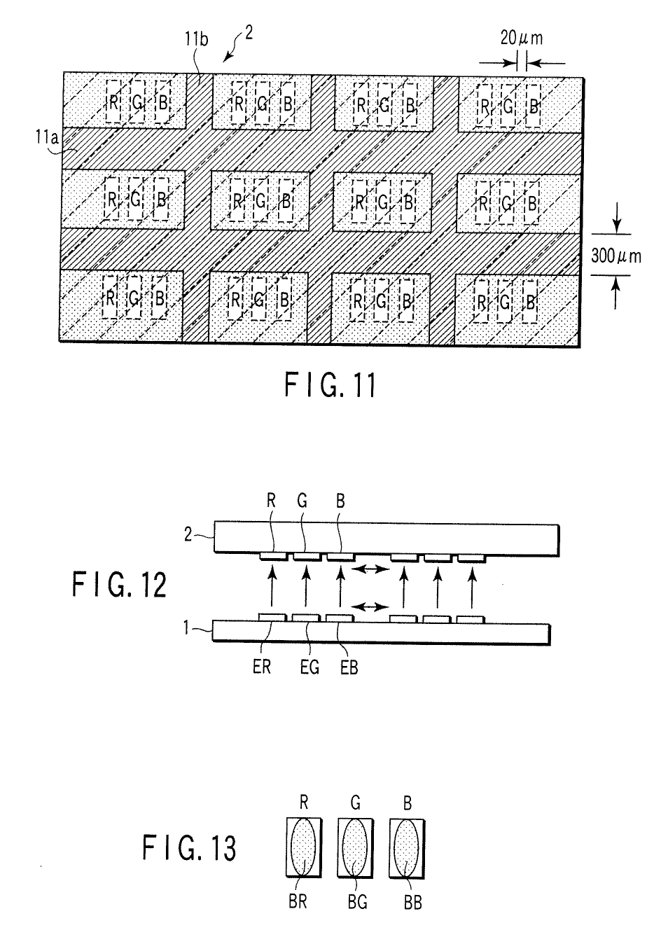

The front substrate including the black light-shielding layer, the phosphor layers, and the metal back layer is further provided with getter segmentation regions 11a and 11b having microstructures at a wide portion around the combinations of the R, G, and B phosphors, as shown in FIG. 11.

The getter segmentation layer forms a granular or stepped structure at least on part of the wide portion of the underlayer, as shown in FIG. 7 or 8. When forming a getter on the underlayer, the microstructures break and electrically segment part of the getter layer. When forming the getter segmentation layer, the underlayer must have a width of, e.g., 50 μm or more and preferably 100 μm or more. This width may be ensured with the conventional arrangement for the horizontal segmentation region 11a, but not for the vertical segmentation region 11b. In view of this, according to the present invention, the R, G, and B phosphor layers are arranged to form groups, so that a sufficient width of the underlayer of the segmentation region 11b is ensured for each of the three colors R, G, and B.

As described above, according to another aspect of the flat panel display device of the second viewpoint, the getter layer has a region including a discontinuous portion around one unit formed of one red-emitting phosphor element, one green-emitting phosphor element, and one blue-emitting phosphor element. The discontinuous portion can be formed by forming the getter layer on the underlayer having microstructures on its surface.

The getter layer is formed on the front substrate and sealed without being exposed to the atmosphere. The getter is electrically segmented by the segmentation regions 11a and 11b to maintain the discharge damage effect described above.

As shown in FIG. 10, the phosphor element interval in the pixel is t1, and the pixel interval W2 is sufficiently larger than t1. This is due to the following reason. In the above arrangement, when forming the getter layer on the layer of the black matrix 32 described above, or on the metal back layer 47 in practice, the creepage distance of the high-resistant portion of the getter layer can be increased in one pixel. In this embodiment, (W1) is 0.45 mm, t1 is 0.05 mm, and W2 is 0.15 mm.

The above example exemplifies a case wherein the high-resistant getter layer is formed on the microstructure portion of the underlayer. However, the present invention is not limited to the above embodiment. In the above example, the high-resistance getter layer is formed to cover the entire portion of the microstructure portion of the underlayer. If such a high-resistance portion is formed on at least part of the microstructure portion of the underlayer, it also falls within the scope of the present invention. This is because the characteristic feature of the present invention resides in that the two-dimensional array of the R, G, and B phosphors is considered to obtain the creepage distance of the high-resistance portion of the getter layer. Accordingly, the segmentation portion can be one column or one row.

Furthermore, according to the present invention, R, G, and B electron-emitting elements are formed at positions corresponding to the R, G, and B phosphors of one pixel. More specifically, as shown in FIG. 12, electron-emitting elements ER, EG, and EB are formed to correspond to the R, G, and B phosphors formed on the front substrate 2. Hence, regarding the array of the electron-emitting elements, the three electron-emitting elements ER, EG, and EB form one unit and correspond to one pixel unit.

In each of the R, G, and B phosphors, the width in the vertical direction perpendicular to the horizontal direction along which the R, G, and B phosphors are arrayed is larger than the width in the horizontal direction. This is because electron beam spots BR, BG, and BB emitted from the electron-emitting elements ER, EG, and EB become vertically long, as shown in FIG. 13. Namely, the spot shapes on the R, G, and B phosphors are ellipses in which the major diameters of the electron beam spots BR, BG, and BB coincide with the vertical directions of the R, G, and B phosphors, respectively. As a result, this shape can provide efficient light emission.

The present invention is not limited to the embodiment described above. The direction of the color pixel array is not limited to that in the above embodiment, but an array of the R, G, and B phosphors can exist in the vertical direction. According to the present invention, when forming the getter layer, the getter layer is formed in the vacuum and directly sealed in the vacuum to form an envelope arrangement. The sizes, materials, and the like of the respective constituent elements are not limited to the values and materials shown in the above embodiment, but various sizes and materials can be selected where necessary.

What is claimed is:

1. A flat panel display device, which has a vacuum envelope including a front substrate and a rear substrate arranged to oppose the front substrate, and in which a phosphor screen, a metal back layer, an underlayer, and a getter layer are sequentially formed on a surface of an image display region of the front substrate on a side close to the rear substrate,
wherein the getter layer comprises a region including a striped discontinuous portion in the image display region, and the discontinuous portion is formed by forming the getter layer on the underlayer provided with microstructures on a surface thereof.

2. A flat panel display device according to claim 1, wherein the getter layer includes a gap having a predetermined interval in a direction intersecting the region including the discontinuous portion.

3. A flat panel display device according to claim 1, wherein the phosphor screen comprises a two-dimensional array of pixels each including a red-emitting phosphor element, a green-emitting phosphor element, and a blue-emitting phosphor element that are arrayed at predetermined intervals to form one unit, and the discontinuous portion is arranged in a region around each pixel.

4. A flat panel display device according to claim 2, wherein the discontinuous portion is segmented by the gap.

5. A flat panel display device according to claim 2, wherein the gap has a width of not less than 100 μm.

6. A flat panel display device according to claim 2, wherein the width of the gap is determined by a width of masking when forming the getter layer.

7. A flat panel display device according to claim 1, wherein the width of the gap comprises a width as an integer multiple of a width of one pixel which includes a red-emitting phosphor element, a green-emitting phosphor element, and a blue-emitting phosphor element as one unit.

8. A flat panel display device according to claim 1, wherein the microstructures on the underlayer comprise a step.

9. A flat panel display device according to claim 2, wherein
the phosphor screen comprises a black matrix including a grid pattern in which a region of either one of a row and a column has a width larger than that of a remaining one, and phosphor layers formed among the black matrix, and the metal back layer on the phosphor screen is electrically segmented at a region corresponding to the black matrix, and
the discontinuous portion of the getter layer is formed into a wide region, and the gap is formed into a narrow region.

10. A flat panel display device, which has a vacuum envelope including a front substrate and a rear substrate arranged to oppose the front substrate, and in which a phosphor screen, a metal back layer, an underlayer, and a getter layer are sequentially formed on a surface of an image display region of the front substrate on a side close to the rear substrate, wherein
the phosphor screen comprises a two-dimensional array of pixels each including a red-emitting phosphor element, a green-emitting phosphor element, and a blue-emitting phosphor element that are arrayed at predetermined intervals to form one unit, and
an interval (W2) of the pixels is larger than an interval (t1) among the red-emitting phosphor element, the green-emitting phosphor element, and the blue-emitting phosphor element.

11. A flat panel display device according to claim 10, wherein the rear substrate includes electron-emitting elements for the red-emitting phosphor element, the green-emitting phosphor element, and the blue-emitting phosphor element at positions which respectively correspond to the red-emitting phosphor element, the green-emitting phosphor element, and the blue-emitting phosphor element of the pixel.

12. A flat panel display device according to claim 10, wherein the getter layer comprises a region including a discontinuous portion around one unit pixel formed of one red-emitting phosphor element, one green-emitting phosphor element, and one blue-emitting phosphor element, and the discontinuous portion is formed by forming the getter layer on the underlayer having microstructures on a surface thereof.

13. A flat panel display device according to claim 10, wherein each of the red-emitting phosphor element, the green-emitting phosphor element, and the blue-emitting phosphor element has a width in a direction of an array of the red-emitting phosphor element, the green-emitting phosphor element, and the blue-emitting phosphor element, which is smaller than a width in a direction intersecting the direction of the array.

14. A flat panel display device according to claim 10, wherein electron beams respectively emitted from the electron-emitting elements form spots on the red-emitting phosphor element, the green-emitting phosphor element, and the blue-emitting phosphor element to have elliptic shapes in which major-axis sizes thereof are equal to major-axis sizes of the respective phosphor elements.

15. A method of manufacturing a flat panel display device, comprising the steps of forming a phosphor screen on an image display region of a front substrate, forming a metal back layer on the phosphor screen, forming an underlayer on the metal back layer, forming a getter layer on the underlayer, and arranging the obtained front substrate and a rear substrate to oppose each other and sealing the front substrate and the rear substrate in a vacuum, wherein
the underlayer comprises microstructures at least on part of a surface thereof, and a getter material is deposited on the underlayer to form a getter layer, having a partially broken discontinuous portion, on a region formed with the microstructures.

16. A method of manufacturing a flat panel display device according to claim 15, wherein at least one striped region with microstructures is formed on the underlayer, at least one striped mask having a predetermined width is arranged in a direction intersecting the region with the microstructures, and deposition is performed to form a striped discontinuous portion in the striped region, and a getter layer, having a gap with a predetermined interval corresponding to the striped mask, in a direction intersecting the striped discontinuous portion.

17. A method of manufacturing a flat panel display device according to claim 16, wherein the discontinuous portion is segmented by the gap with the predetermined interval.

18. A method of manufacturing a flat panel display device according to claim 16, wherein the interval of the gap is not less than 100 μm.

19. A method of manufacturing a flat panel display device according to claim 16, wherein the interval of the gap is determined by a width of the mask when forming the getter layer.

20. A method of manufacturing a flat panel display device according to claim 16, wherein a wire is used as the mask.

21. A method of manufacturing a flat panel display device according to claim 16, wherein the width of the gap comprises a width as an integer multiple of a width of a pixel which includes a red-emitting phosphor element, a green-emitting phosphor element, and a blue-emitting phosphor element as one unit.

22. A method of manufacturing a flat panel display device according to claim 16, wherein the microstructures on the underlayer comprise a step.

23. A method of manufacturing a flat panel display device according to claim 16, wherein the phosphor screen comprises a black matrix including a grid pattern in which a region of either one of a row and a column has a larger width than that of a remaining one, and phosphor layers formed among the black matrix, the metal back layer on the phosphor screen is electrically segmented at a region corresponding to the black matrix, the discontinuous portion of the getter layer is formed in a direction of a wide region, and the gap is formed in a direction of a narrow region.
